(19) United States
(12) Patent Application Publication
(10) Pub. No.: US 2021/0229218 A1
(43) Pub. Date: Jul. 29, 2021

(54) LASER PROCESSING DEVICE AND LASER PROCESSING METHOD

(71) Applicant: SHANGHAI INDUSTRIAL µ TECHNOLOGY RESEARCH INSTITUTE, Shanghai (CN)

(72) Inventors: LI FENG, SHANGHAI (CN); SHINAN WANG, SHANGHAI (CN)

(73) Assignee: SHANGHAI INDUSTRIAL µ TECHNOLOGY RESEARCH INSTITUTE, SHANGHAI (CN)

(21) Appl. No.: 17/152,261

(22) Filed: Jan. 19, 2021

(30) Foreign Application Priority Data
Jan. 23, 2020 (CN) 2020100765282

(51) Int. Cl. B23K 26/38; B23K 26/06; B23K 26/035; B23K 26/08; B23K 26/082

(52) U.S. Cl. CPC B23K 26/38; B23K 26/0643; B23K 26/082; B23K 26/0823; B23K 26/035

(57) ABSTRACT

The present disclosure provides a laser processing device and a processing method for forming a fine structure on a substrate. The laser processing device includes a laser, a stage, an optical system, a pattern generation system, and a control system. The laser emits laser light. The stage supports the substrate. The optical system guides the laser light emitted by the laser to the substrate, thereby irradiating a light beam to the substrate, and the light beam is inclined relative to a surface of the substrate. The pattern generation system prepares a processing pattern of the fine structure. The control system controls the laser, the stage, and the optical system according to the processing pattern.

### BACKGROUND

### Field of Disclosure

The present disclosure relates to the technical field of semiconductors, in particular, to a laser processing device and a laser processing method.

### Description of Related Arts

In the manufacturing process of semiconductor devices, especially MEMS (Micro Electro Mechanical Systems) devices, it is often necessary to form various fine structures such as channels, holes, and perforations through microfabrication. These fine structures sometimes need to be processed directly on the semiconductor substrate, and sometimes need to be processed in a thin film formed on the semiconductor substrate. The processing of these fine structures can be carried out by photolithography and etching, or by direct laser processing.

Compared with photolithography and etching methods, direct laser processing methods have certain advantages. First of all, the direct laser processing equipment is simple, and the construction and operating costs are low. The direct laser processing method is unlike the photolithography and etching method, which needs a complete set of equipment such as photomask preparation equipment, photoresist coating and exposure equipment, developing equipment, etching equipment, and photoresist removal equipment. Besides, the processed byproduct using the direct laser processing method is the raw material of the semiconductor substrate or the thin film formed on the semiconductor substrate, which has a very low impact on the environment. While the photolithography and etching method needs to use gases or liquids that have a burden on the environment, and the processed byproducts are often compounds that have a burden on the environment. However, the traditional direct laser processing method is difficult to achieve oblique processing.

It should be noted that the above introduction to the technical background is only for the convenience of a clear and complete description of the technical solution of the present disclosure, and to facilitate the understanding of those skilled in the art. It should not be considered that the above technical solutions are well-known to those skilled in the art just because these solutions are described in the background part of the present disclosure.

### SUMMARY

The embodiments of the present disclosure provide a laser processing device and a laser processing method, which can process fine structures with a laser beam inclined relative to the surface of the substrate, thereby enabling oblique processing.

According to an aspect of the embodiments of the present disclosure, a laser processing device for forming a fine structure on a substrate is provided. The device includes a laser, a stage, an optical system, a pattern generation system, and a control system. The laser emits laser light. The stage supports the substrate. The optical system guides the laser light emitted by the laser to the substrate, thereby irradiating a light beam to the substrate, and the light beam is inclined relative to a surface of the substrate. The pattern generation system prepares a processing pattern of the fine structure. The control system controls the laser, the stage, and the optical system according to the processing pattern.

According to another aspect of the embodiments of the present disclosure, the laser includes a plurality of laser light sources.

According to another aspect of the embodiments of the present disclosure, the stage tilts and rotates the surface of the substrate relative to a horizontal direction.

According to another aspect of the embodiments of the present disclosure, the stage moves in a horizontal direction and/or a direction perpendicular to the horizontal direction, and rotates around an axis perpendicular to the horizontal direction.

According to another aspect of the embodiments of the present disclosure, the optical system includes a shaping part and a guiding part of the laser beam, the shaping part shapes the laser light emitted by the laser into a beam having a predetermined spot pattern, and the guiding part guides the beam to the substrate.

According to another aspect of the embodiments of the present disclosure, the guiding part comprises a scannable reflecting mirror.

According to another aspect of the embodiments of the present disclosure, the guiding part guides the beam to a front and/or back of the substrate.

According to another aspect of the embodiments of the present disclosure, the optical system further comprises a scanning mechanism that adjusts an emission direction of the beam to change an angle of the beam and a surface of the substrate.

According to another aspect of the embodiments of the present disclosure, the laser processing device further includes a pattern alignment system that aligns a surface to be processed of the substrate with a predetermined pattern.

According to another aspect of the embodiments of the present disclosure, a laser processing method for forming a fine structure on a substrate is provided. The method includes: emitting laser light by a laser; supporting the substrate by a stage; guiding the laser light emitted by the laser to the substrate by an optical system, thereby irradiating a light beam to the substrate, and the light beam is inclined relative to a surface of the substrate; and controlling the laser, the stage, and the optical system according to a processing pattern of the fine structure by a control system.

The beneficial effects of the present disclosure are as follows: the present disclosure can process fine structures with a laser beam inclined relative to the surface of the substrate, thereby enabling oblique processing.

With reference to the following description and drawings, specific embodiments of the present disclosure are disclosed in detail, and the ways in which the principles of the present disclosure can be adopted are indicated. It should be understood that the scope of the implementation of the present disclosure is not limited thereby. The implementation of the present disclosure includes many changes, modifications, and equivalents within the spirit and scope of the terms of the appended claims.

Features described and/or shown for one embodiment can be used in one or more other embodiments in the same or similar manner, combined with features in other embodiments, or substituted for features in other embodiments.

It should be emphasized that the term “comprising/including” when used herein refers to the existence of a feature, a whole member, a step or a component, but does not exclude the existence or addition of one or more other features, whole members, steps or components.

### BRIEF DESCRIPTION OF THE DRAWINGS

The included drawings are used to provide a further understanding of the embodiments of the present disclosure, which constitute a part of the specification, are used to illustrate the embodiments of the present disclosure, and together with the text description, explain the principle of the present disclosure. The drawings in the following description are only some embodiments of the present disclosure. For those of ordinary skill in the art, other drawings can be obtained based on these drawings without creative labor. In the drawings:

FIG. 1 shows a schematic view of a microfabrication device according to the present disclosure.

FIGS. 2a)-2b), and 2e) show cross-sectional views of a stage along the vertical direction.

FIG. 2c shows coordinate axes along which the stage moves.

FIG. 2d shows a rotation angle of the stage.

FIG. 3 shows a schematic view of a laser processing device using laser processing according to Embodiment 2 of the present disclosure.

FIG. 4 shows a schematic view of a laser processing device using laser processing according to Embodiment 3 of the present disclosure.

FIG. 5 shows a schematic view of a laser processing device using laser processing according to Embodiment 4 of the present disclosure.

FIG. 6 shows a schematic view of a laser processing device using laser processing according to Embodiment 5 of the present disclosure.

### DETAILED DESCRIPTION OF THE PREFERRED EMBODIMENTS

With reference to the drawings, the foregoing and other features of the present disclosure will become apparent through the following description. In the specification and drawings, specific implementations of the present disclosure are specifically disclosed, which indicate some implementations in which the principles of the present disclosure can be adopted. It should be understood that the present disclosure is not limited to the described implementations, on the contrary, the present disclosure includes all modifications, variations, and equivalents falling within the scope of the appended claims.

In the description of the following embodiments of the present disclosure, the horizontal direction refers to the direction parallel to the main surface (front and back) of the substrate, that is, the direction of the X-Y plane. The vertical direction refers to the direction perpendicular to the horizontal direction, that is, the direction of the Z axis. The main surface of the substrate includes the front and back of the substrate.

### Embodiment 1

Embodiment 1 of the present disclosure provides a laser processing device for forming a fine structure on a substrate. FIG. 1 shows a schematic view of this embodiment. In this embodiment, the schematic view of FIG. 1 only includes the most basic components of the laser processing device of this embodiment, and the laser processing device may also have other components not shown.

In this embodiment, the substrate to be processed may be a semiconductor substrate or a non-semiconductor substrate. In the following description of this embodiment, a semiconductor substrate is taken as an example. However, the following description is also applicable to the case where the substrate is a non-semiconductor substrate.

As shown in FIG. 1, the laser processing device 100 of this embodiment includes a laser 1, a stage 3 supporting a semiconductor substrate 2, an optical system 5 that guides the laser light (or laser beam) 4 emitted by the laser 1 to the semiconductor substrate 2, a pattern generation system 6 that prepares a processing pattern of a fine structure, and a control system 7 that controls the laser 1, the stage 3, and the optical system 5 according to the processing pattern. As described below, the laser processing device 100 of this embodiment can simultaneously process the fine structure with laser light 4 having a plurality of beams.

The laser 1 may include a plurality of laser light sources. In other words, the laser light 4 may have a plurality of beams. The wavelength, intensity, and waveform of the laser light 4 may be determined according to the requirements of the processed object (semiconductor substrate 2). The laser light 4 may be a continuous wave or a pulse wave. The wavelength, intensity, waveform, and other characteristics of each laser light 4 can be the same as or different from other laser light. In this way, the laser light 4 having a plurality of beams can be used to process the fine structure of the conductor substrate 2.

The semiconductor substrate 2 may be a wafer commonly used in the semiconductor manufacturing field, such as a silicon wafer, an SOI (Silicon On Insulator) wafer, a silicon germanium wafer, a germanium wafer or a gallium nitride wafer, or a SiC wafer, etc. The semiconductor substrate 2 may also be insulating wafers such as quartz, sapphire, and glass. Besides, the semiconductor substrate 2 may also be a wafer commonly used in the field of semiconductor manufacturing, and further have various thin films and structures required for semiconductor devices or MEMS devices on the surface of the wafer.

The stage 3 is a tool for supporting and fixing the processed semiconductor substrate 2. The size of the stage 3 is designed according to the size of the semiconductor substrate 2. The stage 3 may correspond to a semiconductor substrate 2 of a specific size, or may correspond to multiple semiconductor substrates 2 of different sizes. The semiconductor substrate 2 may be fixed to the stage 3 by vacuum adsorption, mechanical fixation, or other common fixation methods. The stage 3 may be moved in the horizontal and vertical directions, or may be rotated in the horizontal direction. In this way, even when the position of the laser beam is fixed, a complicated three-dimensional fine structure processing may be performed on the semiconductor substrate 2.

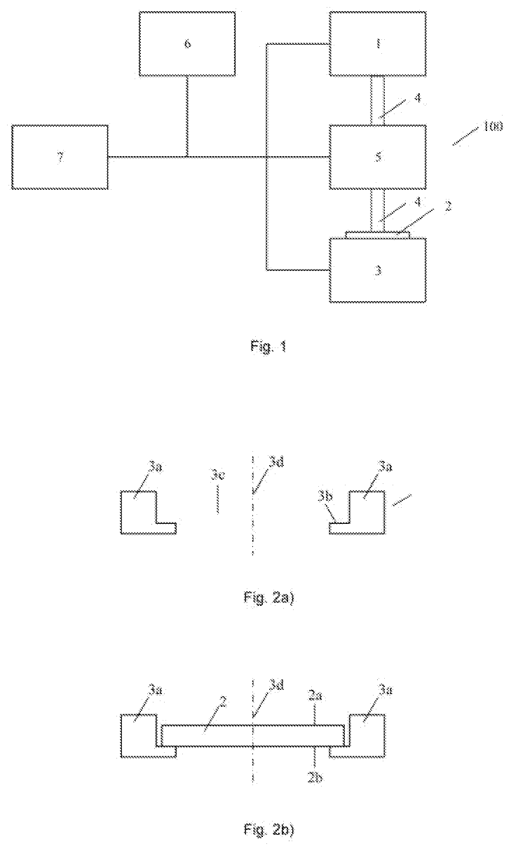

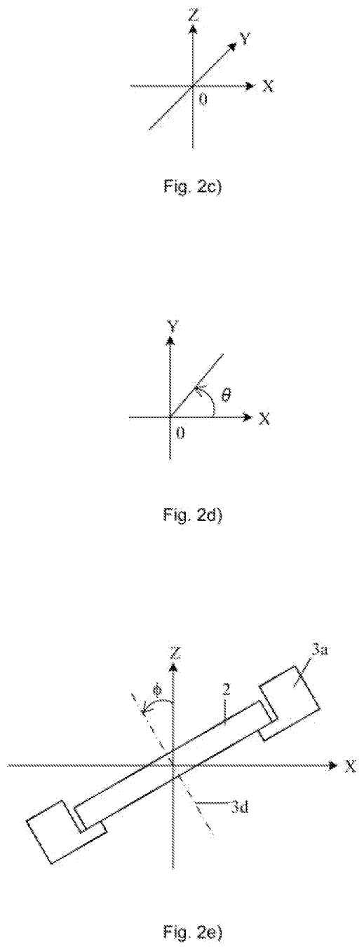

FIGS. 2a)-2b), and 2e) show cross-sectional views of the stage 3 along the vertical direction. As shown in FIG. 2a), the stage 3 includes a stage frame 3a, a semiconductor substrate supporting portion 3b, and a through hole 3c. A central axis 3d in the vertical direction of the stage 3 is shown in FIGS. 2a)-2b) and 2e). The state after placing the semiconductor substrate 2 on the stage 3 is shown in FIG. 2b). The semiconductor substrate 2 is fixed at the supporting portion 3b. The portions to be processed of the two main surfaces 2a and 2b of the fixed semiconductor substrate 2 are all exposed. FIG. 2c shows coordinate axes along which the stage moves. As shown in FIG. 2c), the stage 3 may move in three mutually orthogonal directions of X, Y, and Z. For example, the X axis, and the Y axis are in the horizontal direction, and the Z axis is in the vertical direction and coincides with the central axis 3d of the vertical direction of the stage 3. FIG. 2d shows a rotation angle of the stage. As shown in FIG. 2d), the stage 3 may be rotated in a horizontal plane (horizontal direction) formed by the X axis and the Y axis. That is, the stage 3 rotates around the Z axis. The rotation angle θ of the stage 3 may be any angle within 0-360°. The rotation angle θ may also exceed the range of 0-360°, that is, the stage 3 may be continuously rotated, or may be rotated in the opposite direction. As shown in FIG. 2e), the stage 3 may be inclined relative to the horizontal direction, that is, the central axis 3d of the stage 3 may form an angle φ with the Z-axis direction, −90°<φ<90°. The shift of the stage 3 in the X-axis, Y-axis, and Z-axis directions, the rotation of the stage 3 around the Z-axis, and the inclination of the stage 3 relative to the horizontal direction are independent of each other, but may be performed simultaneously as required.

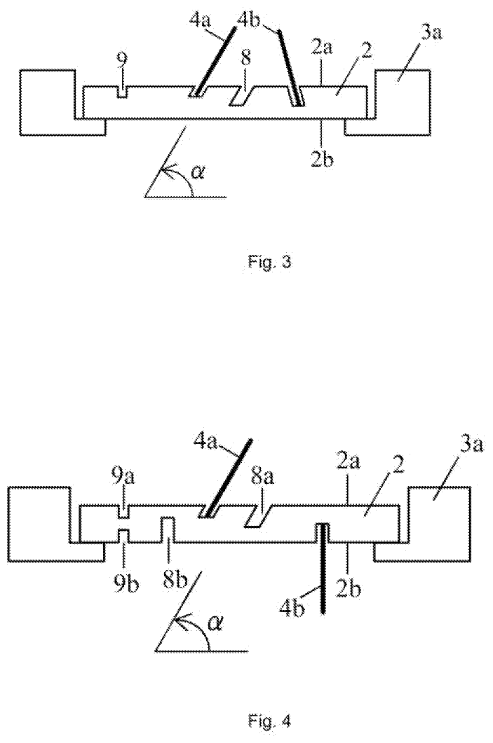

The optical system 5 is a system that guides the laser light 4 emitted by the laser 1 to the semiconductor substrate 2, and may include a shaping part and a guiding part of the laser beam. For example, the optical system 5 may include a lens (i.e. a shaping part), an optical waveguide (i.e., a guiding mechanism), and may also include a scannable reflecting mirror as a guiding mechanism. Such an optical system 5 may shape the laser beam into a required cross-sectional structure (spot pattern) and guide it to the semiconductor substrate 2 to be processed. The optical system 5 may further include a scanning mechanism, which drives the above-mentioned scannable reflecting mirror so that the laser light 4 may move independently of the semiconductor substrate 2. When the laser light 4 moves independently of the semiconductor substrate 2, the incident angle α of the laser light 4 relative to the processed main surface of the semiconductor substrate 2 (see FIG. 3) may be kept fixed or changed at any time as required. For example, when the optical system 5 includes a scannable reflecting mirror, in the range of 90°≥α>0°, the angle α may be fixed at a certain value, or may be changed according to the shape requirements of the processing pattern.

It should be noted that, in FIG. 1, although the optical system 5 is shown to guide the laser light 4 to the front surface of the semiconductor substrate 2, this embodiment is not limited to this, and the optical system 5 may guide the laser light 4 to the front and/or back surfaces of the semiconductor substrate 2. For example, the hollow structure of the stage 3 allows the two main surfaces (i.e., the front and back surfaces) of the semiconductor substrate 2 to be exposed to the outside, allowing light beams to approach, and the optical system 5 may have multiple light paths, thereby guiding a plurality of laser beams to any position of the semiconductor substrate 2, including the front and back surfaces of the semiconductor substrate 2. In each optical path, an optical waveguide may be used as a guiding part to guide the laser beams. In the present disclosure, the optical system 5 guides the laser light 4 to the front and/or back surfaces of the semiconductor substrate 2 respectively, thereby enabling processing of either or both of the front and back surfaces of the semiconductor substrate 2.

The pattern generation system 6 may be used to form the electronic information of the processed pattern of the fine structure to be processed. The pattern generation system 6 may include a computer and drawing software. The electronic information of the processed pattern may contain information such as the size and layout of the fine structure. For example, the pattern generation system 6 may generate electronic information of a three-dimensional processing pattern by drawing or inputting coordinates.

The control system 7 may control the laser 1, the stage 3, and the optical system 5 according to the processing pattern. The control system 7 includes a computer and control software. The control system 7 may share a computer with the pattern generation system 6. The control of the laser 1 by the control system 7 may include controlling on/off, intensity, and waveform of the laser 1. The control of the stage 3 by the control system 7 may include controlling the moving distance and speed of the stage 3 in the horizontal and vertical directions, as well as the angle and speed of rotation in the horizontal direction. The control system 7 may control the optical system 5 to adjust the cross-sectional structure of the laser beam 4, scan the laser light 4, and change the focus point of the laser light 4. When the optical system 5 includes a scannable reflecting mirror, the control optical system 5 may control the scanning range and scanning speed of the laser light 4, and the angle α between the laser light 4 and the main surface of the semiconductor substrate 2 to be processed (see FIG. 3).

As shown in FIGS. 2b) and 2e), when the semiconductor substrate 2 is fixed on the stage 3, the parts to be processed of the two main surfaces 2a and 2b of the semiconductor substrate 2 are exposed. Therefore, the above-mentioned laser processing device may process the fine structure of the two main surfaces 2a and 2b of the semiconductor substrate 2 separately or simultaneously. In such processing, the angle between the sidewall of the formed fine structure and the main surface of the semiconductor substrate 2 may range from 0° to 90° (including 90°).

The above-mentioned laser processing device may further include a pattern alignment system. The pattern alignment system includes a detection mechanism and an alignment mechanism of a pattern alignment mark. When it is necessary to process the fine structure on the two main surfaces of the semiconductor substrate 2 separately or simultaneously, the pattern alignment system may perform pattern alignment on the two main surfaces of the semiconductor substrate 2 separately or simultaneously.

The laser processing device may also include a waste removal system (not shown) to remove waste generated during the laser processing. The waste removal system may be arranged near the stage 3 to facilitate timely removal of waste. For example, a vacuum suction system is arranged near the stage 3 to remove processing waste in time.

As described above, this embodiment provides a laser processing device for forming a fine structure on a semiconductor substrate. By introducing the oblique emitting mechanism of the laser beam or the tilt mechanism of the semiconductor substrate stage, the oblique processing that is difficult to achieve in traditional processing is provided, and the freedom degree of fine structure processing is improved. On the other hand, multiple laser beams may be used to process the fine structure of the semiconductor substrate separately or simultaneously, which improves the production efficiency of the direct laser processing method.

### Embodiment 2

Embodiment 2 of the present disclosure provides a laser processing device and method for forming a fine structure on a semiconductor substrate. FIG. 3 shows a schematic view of this embodiment. The laser processing device in this embodiment has the basic structure and functions described in Embodiment 1, and the related description is omitted here.

As shown in FIG. 3, the features of this embodiment include, the laser processing device 100 may use a plurality of laser beams (for simplicity, only two laser beams 4a and 4b are shown in FIG. 3) to process the fine structure 8 on the main surface 2a of the semiconductor substrate 2 separately or simultaneously. During the processing, the incident angle of the laser light 4 (including laser beams 4a and 4b) relative to the processed main surface 2a of the semiconductor substrate 2 (for example, the angle α between the laser beam 4a and the main surface 2a) may be kept constant, or may be changed as required at any time. For example, in the range of 90°≥α>0°, the angle α may be fixed at a certain value, or may be changed according to the shape requirements of the processing pattern. In this way, it is possible to easily obtain the fine structure 8 in which the sidewall and the main surface 2a of the semiconductor substrate form a required angle. Obviously, in such a processing method, the angle formed by the sidewall of each single pattern in the microstructure 8 and the main surface 2a of the semiconductor substrate may be the same or different. Moreover, the geometric features such as depth and width of each single pattern in the microstructure 8 may be the same or different. Such a free processing according to actual requirements cannot be achieved by traditional photolithography and etching methods.

During the machining process, as shown in FIG. 2c), the stage 3 may independently move in the three mutually orthogonal directions of X, Y, and Z. Besides, as shown in FIG. 2d), the stage 3 may also rotate around the Z axis.

The position alignment of the layout of different structures may be performed by using the alignment mark 9 formed before the processing of the fine structure 8. The processing patterns of the multiple laser beams 4a and 4b may be the same or different.

As described above, this embodiment may use a plurality of laser beams to process the fine structure on the same main surface of the semiconductor substrate separately or simultaneously, and the incident angle of the laser light relative to the processed main surface of the semiconductor substrate may be kept constant or changed at any time as required. In this way, the production efficiency of the direct laser processing method is improved, the oblique processing that is difficult to achieve in the traditional processing and the processing in different angles and different depths are possible, and free processing of fine structure processing is possible.

### Embodiment 3

Embodiment 3 of the present disclosure provides another laser processing device and method for forming a fine structure on a semiconductor substrate. FIG. 4 shows a schematic view of this embodiment. The laser processing device in this embodiment has the basic structure and functions described in Embodiment 1, and the related description is omitted here.

As shown in FIG. 4, the feature of this embodiment is that the laser processing device 100 may use a plurality of laser beams (for simplicity, only two laser beams 4a and 4b are shown in FIG. 4) to process the fine structure 8 (including fine structures 8a and 8b) on two different main surfaces 2a and 2b of the semiconductor substrate 2 separately or simultaneously. In this regard, this embodiment is basically the same as Embodiment 2. The similarities will not be detailed again. This embodiment differs from Embodiment 2 in the following key points: during the processing, the stage 3 is not tilted relative to the horizontal direction, the beam 4a is tilted relative to the surface of the substrate 2, and the beam 4b is perpendicular to the surface of the substrate 2.

As described above, this embodiment may use a plurality of laser beams to process the fine structure on the same main surface of the semiconductor substrate separately or simultaneously, and both the laser light and the stage may be tilted so that the incident angle of the laser light relative to the processed main surface of the semiconductor substrate may be changed flexibly. In this way, the oblique processing that is difficult to achieve in the traditional processing and the processing of different angles and different depths are possible, the freedom degree of fine structure processing is improved, and the production efficiency of the direct laser processing method is improved.

### Embodiment 4

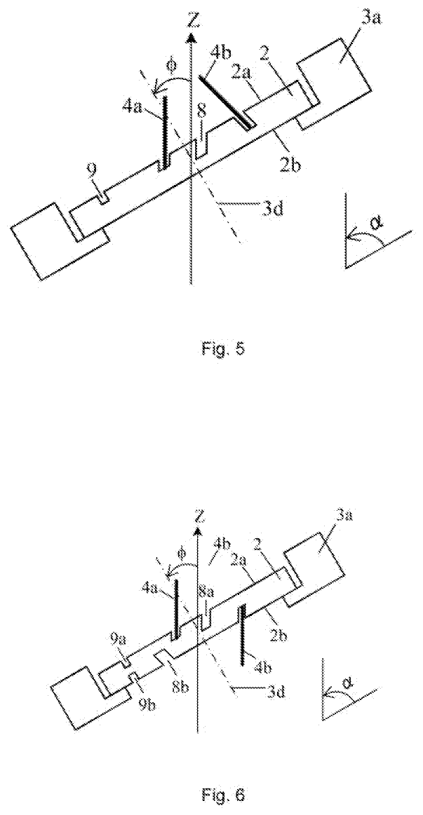

Embodiment 4 of the present disclosure provides a laser processing device and method for forming a fine structure on a semiconductor substrate. FIG. 5 shows a schematic view of this embodiment. The laser processing device in this embodiment has the basic structure and functions described in Embodiment 1, and the related description is omitted here.

As shown in FIG. 5, the feature of this embodiment is that the laser processing device 100 may use a plurality of laser beams (for simplicity, only two laser beams 4a and 4b are shown in FIG. 5) to process the fine structure 8 on the main surface 2a of the semiconductor substrate 2 separately or simultaneously. During the machining process, the shift of the stage 3 in the X-axis, Y-axis, and Z-axis directions, the rotation of the stage 3 around the Z-axis, and the inclination of the stage 3 relative to the horizontal direction are independent of each other, but may be performed simultaneously as required. Since the semiconductor substrate 2 to be processed is fixed on the stage 3, the position change of the stage 3 is equivalent to the position change of the semiconductor substrate 2.

The incident angle of the laser light 4 (including laser beams 4a and 4b) relative to the processed main surface 2a of the semiconductor substrate 2 (for example, the angle α between the laser beam 4a and the main surface 2a) may be kept constant, or may be changed as required at any time. For example, in the range of 90°≥α>0°, the angle α may be fixed at a certain value, or may be changed according to the shape requirements of the processing pattern. In this way, it is possible to easily obtain the fine structure 8 in which the sidewall and the main surface 2a of the semiconductor substrate form a required angle. Obviously, in such a processing method, the angle formed by the sidewall of each single pattern in the microstructure 8 and the main surface 2a of the semiconductor substrate may be the same or different. Moreover, the geometric features such as depth and width of each single pattern in the microstructure 8 may be the same or different. Such a free processing according to actual requirements cannot be achieved by traditional photolithography and etching methods.

During the processing, the stage 3 is inclined at an angle φ relative to the horizontal direction, 90°>φ>−90°.

In addition, during the machining process, as shown in FIG. 2c), the stage 3 may independently move in the three mutually orthogonal directions of X, Y, and Z. Besides, as shown in FIG. 2d), the stage 3 may also rotate around the Z axis.

During the machining process, the shift of the stage 3 in the X-axis, Y-axis, and Z-axis directions, the rotation of the stage 3 around the Z-axis, and the inclination of the stage 3 relative to the horizontal direction are independent of each other, but may be performed simultaneously as required. Since the semiconductor substrate 2 to be processed is fixed on the stage 3, the position change of the stage 3 is equivalent to the position change of the semiconductor substrate 2.

The position alignment of the layout of different structures may be performed by using the alignment mark 9 formed before the processing of the fine structure 8. The processing patterns of the multiple laser beams 4a and 4b may be the same or different.

As described above, this embodiment may use a plurality of laser beams to process the fine structure on the same main surface of the semiconductor substrate separately or simultaneously, and the incident angle of the laser light relative to the processed main surface of the semiconductor substrate may be kept constant or changed at any time as required. In this way, the oblique processing that is difficult to achieve in the traditional processing and the processing of different angles and different depths are possible, free processing of fine structure processing is possible, and the production efficiency of the direct laser processing method is improved.

### Embodiment 5

Embodiment 5 of the present disclosure provides a laser processing device and method for forming a fine structure on a semiconductor substrate. FIG. 6 shows a schematic view of this embodiment. The laser processing device in this embodiment has the basic structure and functions described in Embodiment 1, and the related description is omitted here.

As shown in FIG. 6, the feature of this embodiment is that the laser processing device 100 may use a plurality of laser beams (for simplicity, only two laser beams 4a and 4b are shown in FIG. 6) to process the fine structure 8 (including fine structures 8a and 8b) on two different main surfaces 2a and 2b of the semiconductor substrate 2 separately or simultaneously. During the processing, the stage 3 is inclined at an angle φ relative to the horizontal direction, 90°>φ>−90°. In this regard, this embodiment is basically the same as Embodiments 2-4. The similarities will not be detailed again. The key point that this embodiment differs from Embodiments 2-4 is that the direction of the laser light 4 (including laser beams 4a, 4b) is basically kept fixed, for example, the direction of the laser light 4 is substantially parallel to the Z axis. The advantage is that the control system of the laser light 4 may be relatively simple, but the control system may basically realize the microfabrication described in Embodiments 2-4.

As described above, this embodiment may use a plurality of laser beams to process the fine structure on two main surfaces of the semiconductor substrate separately or simultaneously, and the stage may be tilted. In this way, the oblique processing that is difficult to achieve in the traditional processing and the processing of different angles and different depths are possible, the freedom degree of fine structure processing is improved, and the production efficiency of the direct laser processing method is improved.

The present disclosure is described above in conjunction with specific embodiments, but it should be clear to those skilled in the art that these descriptions are all exemplary and do not limit the protection scope of the present disclosure. Those skilled in the art can make various variations and modifications to the present disclosure according to the spirit and principle of the present disclosure, and these variations and modifications are also within the scope of the present disclosure.

We claim:

1. A laser processing device for forming a fine structure on a substrate, comprising:
a laser, which emits laser light;
a stage, which supports the substrate;
an optical system, which guides the laser light emitted by the laser to the substrate, thereby irradiating a light beam to the substrate, and the light beam is inclined relative to a surface of the substrate;
a pattern generation system, which prepares a processing pattern of the fine structure; and
a control system, which controls the laser, the stage, and the optical system according to the processing pattern.

2. The laser processing device according to claim 1, wherein the laser includes a plurality of laser light sources.

3. The laser processing device according to claim 1, wherein the stage tilts and rotates the surface of the substrate relative to a horizontal direction.

4. The laser processing device according to claim 2, wherein the stage moves in a horizontal direction and/or a direction perpendicular to the horizontal direction, and rotates around an axis perpendicular to the horizontal direction.

5. The laser processing device according to claim 1, wherein the optical system comprises a shaping part and a guiding part of the laser beam, wherein
the shaping part shapes the laser light emitted by the laser into a beam having a predetermined spot pattern,
and the guiding part guides the beam to the substrate.

6. The laser processing device according to claim 5, wherein the guiding part comprises a scannable reflecting mirror.

7. The laser processing device according to claim 5, wherein the guiding part guides the beam to a front and/or back of the substrate.

8. The laser processing device according to claim 5, wherein the optical system further comprises a scanning mechanism that adjusts an emission direction of the beam to change an angle of the beam and a surface of the substrate.

9. The laser processing device according to claim 1, further comprising a pattern alignment system that aligns a surface to be processed of the substrate with a predetermined pattern.

10. A laser processing method for forming a fine structure on a substrate, comprising:
emitting laser light by a laser;
supporting the substrate by a stage;
guiding the laser light emitted by the laser to the substrate by an optical system, thereby irradiating a light beam to the substrate, and the light beam is inclined relative to a surface of the substrate; and
controlling the laser, the stage, and the optical system according to a processing pattern of the fine structure by a control system.
